(19) United States
(12) Patent Application Publication
(10) Pub. No.: US 2006/0100905 A1
(43) Pub. Date: May 11, 2006

(54) Claim data processing system

(76) Inventor: James D. Christen, Downingtown, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/252,058

(22) Filed: Oct. 17, 2005

Related U.S. Application Data
(60) Provisional application No. 60/620,542, filed on Oct. 20, 2004.

(51) Int. Cl. G06Q 10/00

(52) U.S. Cl. 705/2

(57) ABSTRACT

A system for processing claim data related to provision of healthcare to a patient includes an interface processor for receiving data related to a claim for provision of healthcare to a particular patient and including a claim type identifier. At least one repository includes predetermined claim generation rules for use in generating a claim for submission to a payer institution. The claim generation rules are hierarchically organized to enable more frequently applied rules to be identified and applied first. The repository also includes information associating particular rules to be applied with a particular claim type. A claim processor generates a claim of a particular type for submission to a particular payer institution by applying claim generation rules derived from the repository in a predetermined priority in response to the received claim type identifier.

The present application derives priority from U.S. Provisional Patent Application No. 60/620,542, filed on Oct. 20, 2004.

### FIELD OF THE INVENTION

The present invention relates generally to the field of data processing, and more particularly to a rules engine that facilitates the processing of claims for payment.

### BACKGROUND OF THE INVENTION

Large multiple entity enterprises, such as a regional or national healthcare providers, generate a substantial number of claims for payment as a result of the healthcare services rendered to patients. The various payers of the claims can include insurance companies as well as local, state and national government sponsored programs. Each payer can have differing rules regarding the claim format and content. Substantial claim content and format commonality can also exist between various payers. Numerous claim production and processing systems have been developed to address the diversity of potential payers.

Existing claim production systems tend to be labor intensive and involve substantial manual intervention in order to address gaps and inconsistencies in requirements management, specifications, programming, testing and implementation of claims. Present claims processing is highly dependent on the knowledge of subject matter experts as well as undocumented information. Known systems are dependent on subject matter experts to both interpret and translate information contained within payer rules and companion guides. Often the subject matter expert is required to supplement existing documentation with experiences from prior analyses and claims implementations, and the expert frequently utilizes his ability to leverage informal business relationships among payers and providers.

One existing system employs a database of payer companion guides to be used by healthcare providers in order to implement the testing of healthcare claim transaction sets using the American National Standards Institute (ANSI) 837 data format. Existing systems fail to adequately accommodate national, regional, and local standards for a bill format or claims transaction and often fail to accurately process claims where these standards intersect. The existing systems are cumbersome to modify, and produce results that are highly erratic and unpredictable. A system according to the principles of the present invention addresses these deficiencies and related problems.

### BRIEF SUMMARY OF THE INVENTION

In accordance with principles of the present invention, a system for processing claim data related to provision of healthcare to a patient includes an interface processor for receiving data related to a claim for provision of healthcare to a particular patient and including a claim type identifier. At least one repository includes predetermined claim generation rules for use in generating a claim for submission to a payer institution. The claim generation rules are hierarchically organized to enable more frequently applied rules to be identified and applied first. The repository also includes information associating particular rules to be applied with a particular claim type. A claim processor generates a claim of a particular type for submission to a particular payer institution by applying claim generation rules derived from the repository in a predetermined priority in response to the received claim type identifier.

### BRIEF DESCRIPTION OF THE DRAWING

In the drawing:

FIG. 1 is a block diagram of a claim processing system constructed according to the principles of the present invention;

FIG. 2 is a block diagram of the architecture used by the present invention in processing a claim;

FIG. 3 is a block diagram depicting the data flow utilized by the present invention when processing a Uniform Bill-92 (UB92) claim form;

FIG. 4 is a diagram listing the form locator codes for a UB92 claim form;

FIG. 5 is list of individual data segments present in the header of an ANSI compatible claim transaction;

FIG. 6 is list of individual data segments present in the billing hierarchy detail of an ANSI compatible claim transaction;

FIG. 7 is a depiction of the data segment NM1 as specified by the ANSI 837I claim data standard;

FIG. 8 is a loop diagram depicting the processing of the NM1 data segment illustrated in FIG. 7 according to the present invention;

FIG. 9 is a diagram of an array of EDI data segments as processed by the present invention;

FIG. 10 is a flow chart depicting a data processing loop for the ISA data segment illustrated in FIG. 9 according to the present invention; and

FIG. 11 is a block diagram of a computer system on which the claim processing system according to the present invention may be implemented.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprises any combination of, hardware, firmware, and/or software.

An executable application, as used herein, comprises code or machine readable instructions for conditioning the processor to implement predetermined functions, such as those of an operating system, claim data processing system or other information processing system, for example, in response user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A calling procedure is a procedure for enabling execution of another procedure, e.g. a called procedure, subprocedure or subroutine, in response to a received command or instruction. An object as used herein comprises a grouping of related data, executable instructions or a combination of both.

A user interface comprises one or more display images, generated by the display processor under the control of the processor, enabling user interaction, via input devices, with a processor or other device. A window as used herein comprises an image area on a display device used for display of desired text or graphics or other content to a user and is not limited to a Microsoft or any other particular operating environment.

The term ‘claim elements’ or “claim data elements” as used herein may comprise a portion of a claim, a complete claim, individual records of a claim and/or record data associated with an individual patient encounter with a healthcare service provider. A rule as used herein comprises a procedure (including an executable procedure and/or a procedure implemented with manual intervention) for determining that healthcare claim elements comply with predetermined requirements including, health plan reimbursement conditions, health plan format requirements, a reimbursement formula, reimbursement constraints and a reimbursement computation procedure. A rule also may comprise a prescribed guide, a precept, or a model for how to present, conduct or regulate an action by using a form and data or the relations between form and data. An exception as used herein encompasses the identification of an issue and mechanism to process that issue. An encounter as used herein comprises a patient encounter with a healthcare enterprise involving patient and healthcare enterprise interaction that has a financial or transaction consequence and may include for example a patient visit, phone call, inpatient stay or outpatient treatment etc.

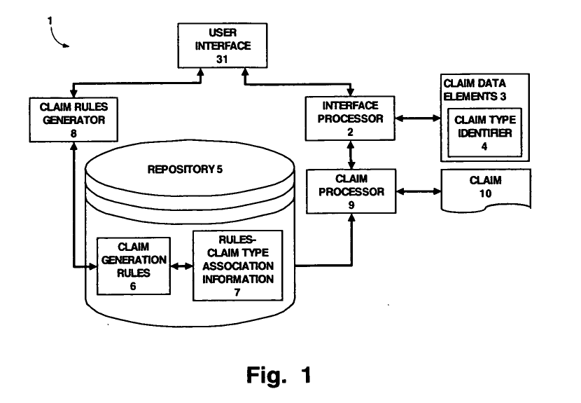

An overview of an embodiment of a claim data processing system 1 constructed according to the principles of the present invention is depicted in FIG. 1. The system 1 includes an interface processor 2 for receiving claim data elements 3. The claim data elements 3 include data related to a claim for payment as a result of the provision of healthcare to a particular patient. The claim data elements 3 further includes a claim type identifier 4. The claim type identifier 4 identifies the claim as, for example, an ANSI 837 compatible electronic claim, a UB92 claim, an American Dental Association (ADA) standard compatible claim, a Health Care Financing Administration (HCFA) standard compatible claim or as a specialty claim, such as a claim for an organ transplant.

The claim data elements 3 are forwarded via interface processor 2 to the claims processor 9, which creates the actual claim 10 according to the architecture of system 1. One feature of the system architecture is a claim rules generator 8 which specifies one or more attributes of respective claim processing rules 6. Some of the rules 6 translate claim data from one format, location or protocol into a different format, location or protocol.

The system 1 reduces implementation resource requirements by allowing a user, via user interface 31, to tailor rules 6 to meet specific requirements. The user interface 31 comprises one or more display images enabling user interaction, via input devices (not shown), with a processor or other device present in system 1. The rules 6 are stored in a repository 5, which is a non-volatile tangible storage medium. The rules 6 incorporate machine readable instructions for processing a claim. The repository 5 further includes information 7 that associates each rule 6 with claim data elements 3 associated with a particular claim type identifier 4. The interface processor 2 also acquires rule data via user interface 31 and transforms the acquired rules 6 into syntax suitable for storage in rules repository 5. In the illustrated embodiment, the rules repository 5 is represented by a single repository. In other embodiments, the rules repository 5 may be arranged as a single or multiple repositories in different arrangements.

The claim data elements 3, claim type identifier 4, rules 6 and association information 7 are analyzed by claim processor 9 to create the claim 10. Logically, the claim rules 6 are advantageously hierarchically organized within repository 5 to enable more frequently applied rules 6 to be identified and applied during claim generation prior to the application of less frequently applied rules.

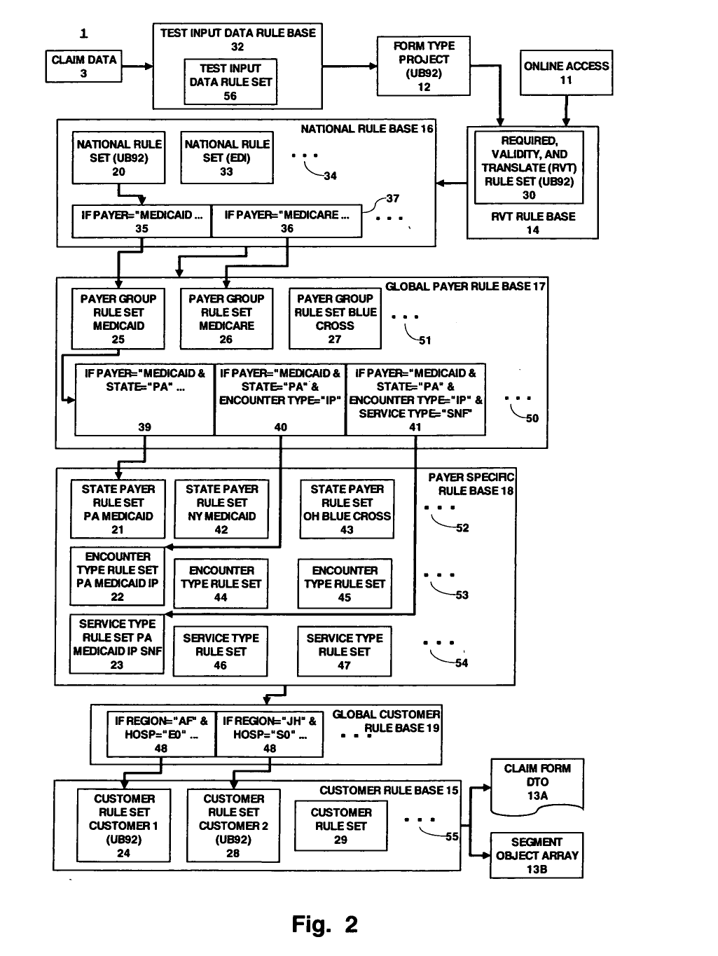

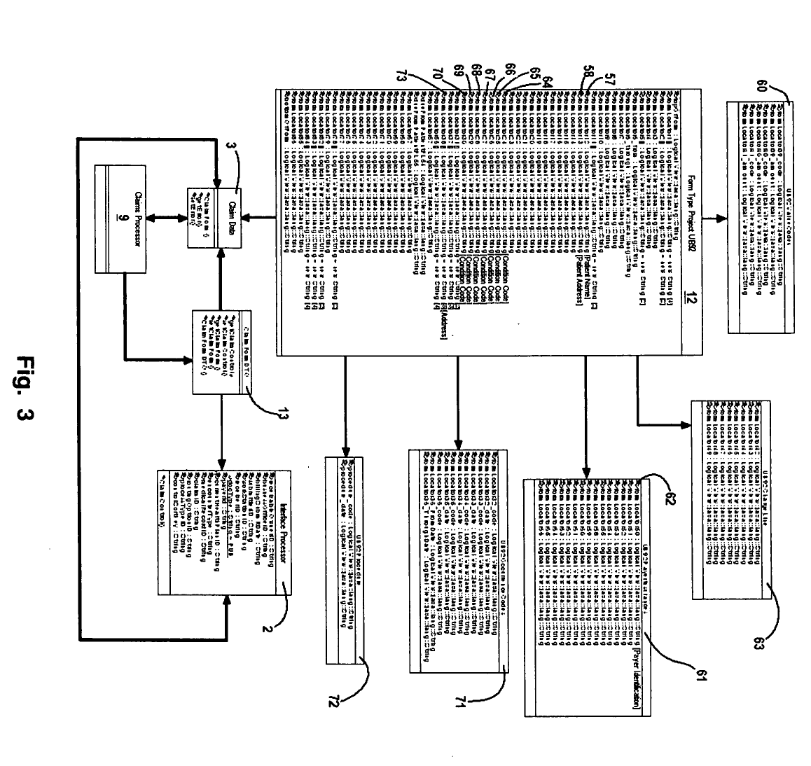

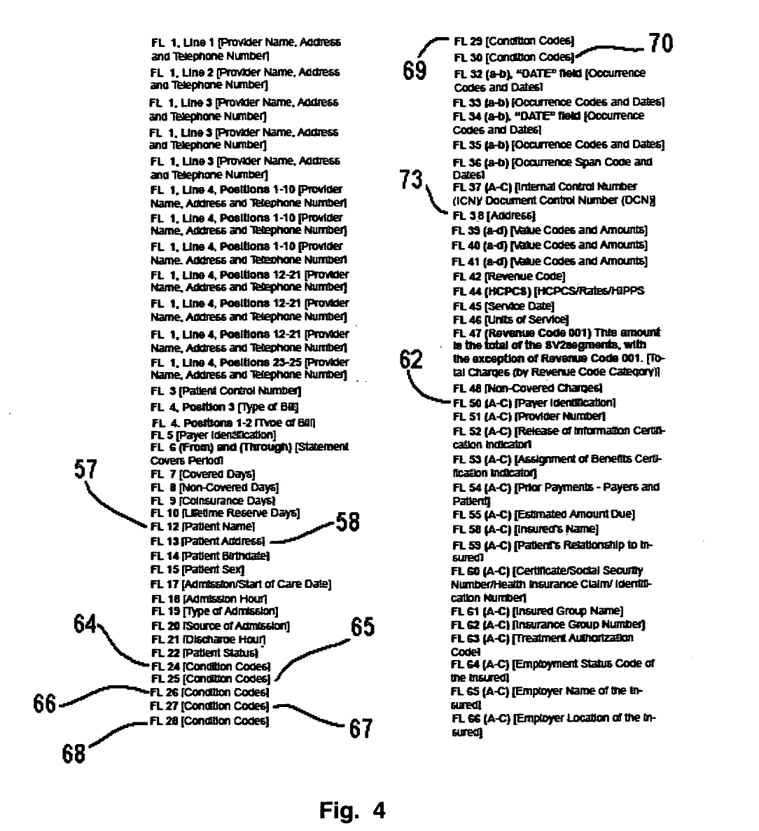

In FIG. 2, the overall architecture of the claims form processing system 1 is described. In FIG. 2 it is assumed that the system 1 needs to produce an IP (inpatient) form UB92 for Medicaid for a particular patient encounter. This determines the need to access a ‘UB92 form type project’ 12. One skilled in the art understands a UB92 form consists of fixed length records of 192 bytes. Each record has a unique identifier and contains logically related data elements. Each individual claim type, as indicated by a corresponding claim type identifier 4 (FIG. 1), is associated with a separate project 12.

For a paper claim, the present system 1 produces a Claim Form Data Transfer Object (DTO) 13A that represents the claim 10 in printable paper format. Respective Claim Form DTOs 13A are specified for each paper form type. For electronic claims the present system 1 produces an array of segment objects 13B in a particular order (described in more detail below). The segment object array 13B comprises an electronic transaction because the segment objects consist of property elements appropriately filled according to the claim processing rules 6 of the present system 1.

The claim generation rules 6 residing within the repository 5 (FIG. 1) are partitioned into rule bases and rule sets. The rule bases illustrated in FIG. 2 are rule base 14 (e.g. required, validity and translate (RVT) rule base), rule base 15 (Customer rule base), rule base 16 (National Rule base), rule base 17 (Global Payer Rule base), rule base 18 (Payer Specific Rule base), rule base 19 (Global Customer Rule base), and rule base 32 (Test Input Data Rule base). The rule bases are organizational structures for separating, maintaining, and deploying rule sets. The system 1 may include other rule bases than those illustrated in FIG. 2.

The respective rule bases (14, 15, 16, 17, 18, 19 and 32) contain at least one rule set. Rule sets are sets of rules grouped together because of their applicability to a common theme or situation. In the illustrated embodiment, rule sets include, among others, rule set 56 (Test Input Data rule set), rule set 20 (National rule set—UB92), rule set 21 (State Payer rule set—PA Medicaid program), rule set 22 (Encounter type rule set for PA Medicaid Inpatients), rule set 23 (Service type rule set for PA Medicaid Inpatients), rule set 24 (Customer rule set for a specific healthcare organization), rule set 25 (Payer group rule set for Medicaid), rule set 26 (Payer group rule set for Medicare), rule set 27 (Payer group rule set for a specific insurer, i.e. Blue Cross), rule set 30 (RVT rule set) and so forth. Payer specific rule sets can include, for example, payer encounter rule sets, i.e. 44, 45, 53 and/or payer service related rule sets, i.e. 46, 47, 54. Similarly, healthcare provider institution (e.g. customer) specific rule sets, i.e. 24, 28, 29, 55, include healthcare provider service and/or procedure specific rules.

The test input data rule set 56 provides hard coded test data objects which may be used to regression test rules as users change the rules. This provides predetermined test data to verify that user changes to the remaining rules provide accurate claim processing.

The RVT rule set 30 includes, for example, rules having general applicability, such as a rule that verifies a time period of validity for respective individual rules, thereby permitting the claims processor 9 (FIG. 1) to examine the validity period and prevent application of a rule at a time and date falling outside of the rule validity period. More specifically, in the illustrated embodiment, respective individual rules 6 in the rules repository 5 include data representing a time period of validity An RVT rule in the RVT rule set 30 in the RVT rule base examines the rule validity period in a rule and does not apply that rule at a time and date falling outside of the rule validity period. Such validation rules may be written once and used to validate batch claim data as well as revenue management inflow data.

Rule bases may be associated with more than one project, i.e. more than one claim form whether paper or electronic. Rule bases allocated to more than one project allow hard coded, generally applicable, input data to be placed in a separate rule base and used for testing other projects and forms. Groupings of rule sets into rule bases permit different support personnel to work concurrently on different payer, customer, or national level rules. Rule changes are versioned at a rule base level and are deployed at a rule base level to customers.

There are, for example, eight levels of rule sets to be applied in sequential order when executing the rules needed to submit claim data elements 3. This protocol applies for both paper and electronic claims. The order of potential rule set execution is:

1. Test Input Data rule set 56;

2. Required, Validity, & Translate (RVT) rule set 30;

3. National rule sets 20, 33, 34;

4. Payer group rule sets 25, 26, 27, 51;

5. Specific payer rule sets 21, 42, 43, 52;

6. Specific payer encounter type rule sets 22, 44, 45, 53;

7. Specific payer service type rule set 23, 46, 47, 54; and

8. Customer rule sets 24, 28, 29, 55.

In general, the hierarchically organized claim generation rules include at least a first rule and a second rule. The second rule is applied subsequent to the first rule and may override a function performed by said first rule. A minimum rule hierarchy executes the RVT rule set 30 (RVT rule base 14) and national rules 20, 33, 34 (national rule base 16) to produce a claim 10 (FIG. 1). When rules exist at payer group, state payer, encounter, service type and health provider levels, those rules are also executed in hierarchical order, from widest coverage (e.g. state or payer group) and therefore most frequently applied, to narrowest coverage (e.g. customer or healthcare organization) and therefore least frequently applied. In short, more generic rules are applied before more specific rules. Each successive level of rules has the capability to overwrite the data produced by or otherwise cancel previously executed rules by reformulating a field output that may have been defined by other more generic rules. Some of the lower level rule sets are conditionally executed based on the data that is received. If the conditions are not met, and no rules are applicable at some of the levels, no rules are executed at those levels. In this way the goal of executing the minimal number of rules to produce a particular claim is accomplished. Overwritten or cancelled rules at successively lower levels, therefore, allow a given collection of rules to process as many situations as necessary while utilizing and storing the smallest possible number of rules.

Higher level rules apply to multiple similarly situated parties or events, such as nationally applied requirements, multiple payers or encounters, etc., and therefore may be written only once and yet cover many situations. This lowering the number of rules which need to be maintained leading to increased efficiency and consistency (e.g. reducing the chance that the same rule may be implemented differently in two different places). As an example, if a national rule requires moving the patient name to a predetermined position on a form and that rule applies to many payers, the present system 1 includes a single rule which writes the patient name to the predetermined location in a predetermined format. Later, in the case of a particular payer, a specific payer rule may be stored which implements overriding the location holding the patient name with some other data or in some other format. In the case of this one specific payer, the system 1 has improved overall efficiency by writing the patient name once in the generic location and format for many payers and overwriting the name once for the one specific payer; as compared to writing and maintaining multiple duplicate rules to move the patient name to the same position on the same form for every one of many individual payers.

In the example shown in FIG. 2, claim data elements 3 are initially processed to determine the type of claim form. In the illustrated embodiment, the system 1 determines that the claim type data requires the UB92 project 12. The appropriate project executable application (in this example the UB92 executable application) is launched with an input parameter indicating that batch claim processing is desired.

When the UB92 project type 12 is selected, the claim data elements 3 are forwarded to the RVT rule base 14. The “required, validity, and translate” (RVT) rule base 14 contains RVT rule set 30 which examines the claim data elements 3 for RVT compliance. That is, the RVT rule set 30 tests the claim data elements 3 to determine that required elements are present, that the values of the data elements are valid and to translate the values of elements as necessary Once the claim data elements 3 exits the RVT rule base 14, the data is processed by the national rule base 16, which contains the rule sets that are most likely to contain rules having national applicability. The national rule base 16 contains, for example, national rule sets 20 and 33, with the ellipsis 34 signifying that any number of further national rule sets may be created for different types of forms, formats or data processing situations.

The system 1 advantageously employs a layered approach in overriding values which are set or modified by a national or standard rule set in order to produce a claim 10 (FIG. 1). The rule sets are applied in a particular order, with the last rules that are applied to the claim data elements 3 being used to make the final changes to the claim form output 10. In the illustrated UB92 paper form example, the national rule set 20 (UB92) is applied first. The national rule set 20 contains those rules which are most likely to be applied in every situation for the form UB92 data format. If a different project e.g. an EDI claim, is specified, a different national rule set, e.g. national rule set 33, may be applied instead. The processed claim data elements 3 are forwarded to the group rule set 37 which contains rules, including rules 35 and 36, for example, which are of general applicability for determining the appropriate payer of the claim.

Once the type of payer has been determined, e.g. by rules 35 and/or 36 within the national rule base 16, the processed claim data elements 3 are forwarded to the Global Payer rule base 17, which applies rules likely to have general applicability to the payer group determined by the national rule base 16. Assuming the payer group is Medicaid, for example, the Medicaid rules regarding location 39 (e.g. PA), type of encounter 40 (e.g. inpatient), type of service 41 (i.e. skilled nursing facility), and other applicable rules 50 are applied. Based on the Payer identification, the processed claim data elements 3 are forwarded to the appropriate rules set within the Payer Specific Rule base 18, which contains various payer specific rule sets. Continuing with the present example, a Pennsylvania (PA) Medicaid claim identified by rule 39 is forwarded to the PA Medicaid rule set 21. A PA Inpatient Medicaid encounter identified by rule 40 is forwarded to payer specific rule set 22, and a PA service type encounter identified by rule 41 is forwarded to payer specific rule set 23.

Once the claim data elements 3 are examined by the payer specific rule base 18, the processed claim data elements 3 are forwarded to the Global Customer Rule base 19, which contains rules 48 and 49, for example, pertaining to the identification of the particular healthcare provider or customer. For example, if a claim is from a region identified by identifier “AF” and a hospital identified by an identifier “E0”, the customer is identified as ‘Customer 1’; if a claim is from a region identified by identifier “JH” and a hospital identified by an identifier “S0”, the customer is identified as ‘Customer 2’. Once the particular customer has been identified, the claim data elements 3 are forwarded to the Customer rule base 15 for examination by the appropriate customer rule set 24 (e.g. ‘Customer 1’), 28 (e.g. ‘Customer 2’), or 29, for example.

In this manner the system 1 executes a minimum set of rules, while preserving the flexibility to produce accurate and complete payer/customer specific claims. Because the rules are applied in a hierarchical fashion there is no need to maintain duplicate copies of the same rule for the complete set or for subsets of payers and/or customers. Instead, a single copy of a rule used in common in different circumstances is elevated to a higher level such as the global payer rule base 17, for example, which contains the more frequently applied rules that are used for producing a claim type for a group of payer institutions. The more frequently applied rules also include rules for identifying, in prioritized order, a particular claim type for a particular payer institution, a particular encounter type and a particular service or procedure type. Individual payer specific rules 18 reside at lower levels. Some rule sets are shared between online and batch applications. For example, the required, validity, and translate (RVT) rules set 30 is shared via online access 11. The healthcare provider institution, e.g. customer, specific rule sets 24, 28 and 29 are applied last. Each healthcare provider institution rule set, such as rule sets 24, 28 and 29, for example, is separately accessible and updateable by a user, independently of other rules, via user interface 31 (FIG. 1) in order to permit maintenance of its own rules, thereby enabling a user to tailor payer rules to meet specific contract parameters.

Referring again to FIG. 1, the user interface 31 allows a user to follow a workflow that allows the user to enter specifications from national requirements such as ANSI X12 837 version 4010, state specific requirements such as, for example, Pennsylvania. (PA) Medicaid, payer specific requirements such as a Blue Cross companion guide for Medicare part A, as well as specific rules set forth in a contract between a given healthcare provider and a particular insurer. The user interface 31 is implemented so that the national implementation specifications are maintained with various help screens that explain the specification. Users access the rules 6 to modify them according to known specifications. Thus, if a national implementation describes a component as being required and having certain characteristics, the present system 1 does not allow the use of specifications other than those that are permitted. However, if the component is available to be modified (termed ‘addressable’), the system 1 accepts alterations and revisions according to known system values contained within edit modules. These edit modules include pre-configured data representing permitted specifications and any other configuration data necessary to maintain accurate and complete generation of claims.

A paper claim, such as the UB92 claim form, is represented by a core object with relationships to repeating groups of data, also represented by objects. Referring to FIG. 3 and FIG. 4, a specific example of generating a paper claim may be understood. As described above, an individual output claim form is associated with a corresponding particular project. Input claim data elements 3 initially determine which project is executed as the system 1 (FIG. 1) operates. The UB92 data format includes eighty six form locators—FormLocator1 (FL1) through FormLocator86 (FL86) corresponding to particular data elements. Data elements which are the same are identified by the same reference number in both FIG. 3 and FIG. 4.

In FIG. 3, the form locators are illustrated as grouped in various logically related categories, such as the core data category 12, and the repeating categories: e.g. the payer insurance category 61, the occurrence codes category 71, the UB92 procedure codes category 72, the UB92 value codes category 60 and the UB92 charge line codes category 63, and so forth. The categories are represented by corresponding objects. The repeating form locator categories 60, 61, 63, 71 and 72 include subsets of the eighty six UB92 form project 12 FormLocator entries, and more than one such object may exist. For example, multiple occurrence procedure code objects 72 may exist containing data related to respective multiple procedures performed on the patient represented by the claim. The multiple procedure code objects 72 are associated with the core data object 12.

In FIG. 4, the form locators (FL) are illustrated in textual manner, as them might be printed on a paper form. Only 66 form locators (FL 1 through FL66) are illustrated in FIG. 4, although one skilled in the art understands that the form locators which are necessary for a complete claim are included in a printed claim form.

The system 1 (FIG. 1) next executes the UB92 national rule set 20 (FIG. 2) which contains, for example, approximately one hundred separate rules regarding data protocol, although a total of hundreds of thousands of rules used for producing claims may reside within the repository 5. The national rule set 20 evaluates the claim data elements 3 and fills in as many of the eighty-six form locators as the national rule set 20 can accomplish. For example, the national rule set 20 causes the patient name in the claim data elements 3 to be copied to the Patient Name FormLocator12 (FL 12) 57, and the patient address is moved to the Patient Address FormLocator13 (FL 13) 58. This process continues until the rules in the national rule set 20 have been processed.

The system 1 (FIG. 1) next determines from the claim data elements 3 that the example UB92 claim is for Medicaid and executes the Medicaid rule set 25 (FIG. 2). The rule set 25 includes, for example, a rule that requires that the Patient Name be in last name, first name, and middle initial order for Medicaid claims. This rule accordingly reformats the Patient Name and overlays the data that previously existed in the Patient Name FormLocator12 (FL 12) 57.

The claim data elements 3 are next examined by the global payer rule base 17, which determines, for example, that the present claim encounter is for PA Medicaid, thus initiating the application of the PA Medicaid rule set 21 (FIG. 2). The rule set 21 requires that other payers that could otherwise be listed on FormLocator50 (FL 50) should be omitted. In FIG. 3, FormLocator50 62 is a data element within the Payer Identification object 61. The claims processor 9 therefore causes blank spaces to be overlaid on any other payers listed for this claim on FormLocator50 62.

The claims processor 9 next determines that this is an inpatient Medicaid Claim, and thus causes the data elements 3 to be examined by the PA Medicaid IP rule set 22 (FIG. 2). One rule contained within rule set 22 requires, for example, that any condition code of “123” in Condition Code FormLocator24 (FL 24) through FormLocator30 (FL 30) 64, 65, 66, 67, 68, 69 and 70, needs to be transformed into a condition code of “456”. The transformation rule is thus executed and translates “123” into “456” wherever found in FormLocator24 (FL 24) through FormLocator30 (FL 30).

The rules hierarchy next progresses to the global customer rule base 19 (FIG. 2), which identifies this claim as originating with a particular healthcare provider, Customer 1. The rules in rule set 24 are, thus, executed This provider requires the address of the billing office of the first hospital in FormLocator38 (FL 38) 73. A rule in rule set 24 executes and changes the data in FormLocator38 (FL 38) 73 to be the address of the billing office of the hospital. The rules have now been executed, and the resulting UB92 form data elements 3 are passed to a rendering function within claims processor 9 which takes the processed data and creates a claim form data transfer object DTO 13A which may be accessed to extract data required to print the claim data in the appropriate positions on a physical UB92 form.

Alternatively an electronic form may be generated and communicated to a desired destination. The present system 1 supports electronic data interchange (EDI) claims processing, which is the transfer of data between different organizations using electronic communications networks, such as the internet or other on-line access 11 (FIG. 2). In this case, a different form type project (not shown) is performed to generate claim data for use in an electronic (EDI) claim. Both paper and electronic claim projects 12 use the hierarchically organized rules. The implementation of those rules varies between the use of rule sets and functions. In a healthcare context, the individual data segments, their properties, and the order of their placement in the transaction are structured so as to be compatible with the ANSI 837 standard for EDI transactions. EDI claims processing includes transaction set standards such as the ANSI X12 837I (institutional billing), 837P (professional billing), and 837D (dental billing). The transaction set standards are set forth in the National Electronic Data Interchange Transaction Set Implementation Guide, published by the Washington Publishing Company, 301 W North Bend Way Suite 107, P.O. Box 1538, North Bend Wash. 98045.

In the illustrated embodiment an electronic transaction is represented in the system 1 (FIG. 1) by an ordered array of data segment objects 13B. A data segment is associated with a number of properties. The data segment properties are either valued or left unvalued by the system 1 depending on where the segment resides within the hierarchy. The assigning of values to the segments is accomplished by passing parameters to functions that construct the individual segments. Rules for formulating individual data segments are written once and shared amongst the 837I, P and D projects.

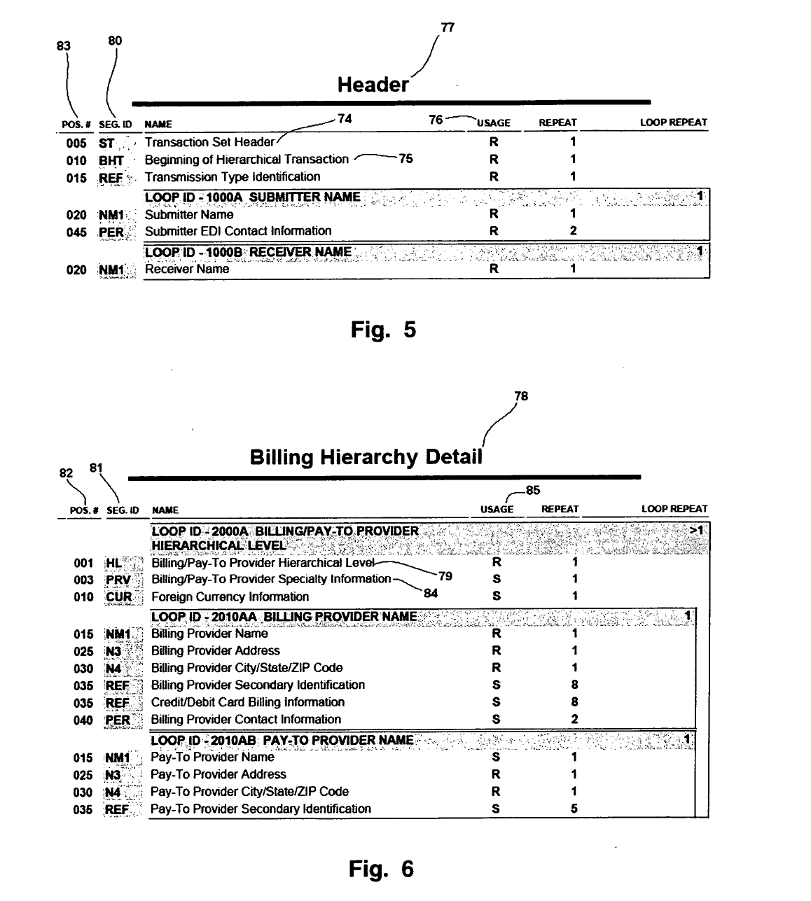

Referring to FIG. 5, the data protocol, or format, of the header 77 is illustrated. The header 77 includes a transaction set header 74, which indicates the start of a transaction set and assigns a control number to that set. The transaction set header 74 includes a segment identifier 80 having the value “ST” and a segment position 83 occupied by the transaction set header 74 having the value position 005. The use of the transaction set header 74 is indicated as required (“R”) in the usage column 76. The header 77 further includes a “Beginning of Hierarchical Transaction” segment 75 having a segment identifier 80 of “BHT” and occupying position 010. The BHT data segment defines the business hierarchical structure of the transaction set and identifies the business application purpose and reference data such as the number, date, and time. In a similar manner, the header 77 includes other data illustrated in FIG. 5 but not described in detail here.

Referring to FIG. 6, an example of the ANSI 837I (institutional) data protocol is illustrated, depicting the characteristics of the billing hierarchy detail 78. A data segment 79, for example, identifies dependencies among and the content of hierarchically related groups of data segments. Data segment 79 has a segment position 82 having the value 001 and a segment identifier 81 having the value “HL”. A data segment 84 specifies the identifying characteristics (specifically the specialty) of a healthcare provider. The data segment 84 includes a segment identifier 81 having a value “PRV”, and has a position 82 having a value 003. The usage 85 of the PRV segment is indicated as situational and has a value of “S”.

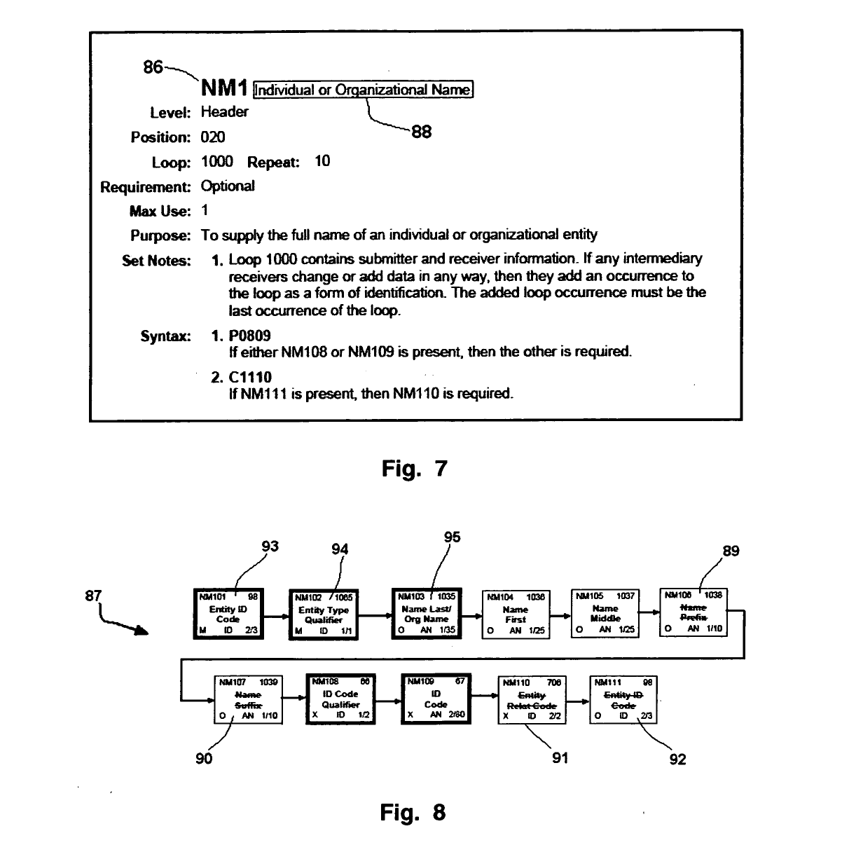

In FIG. 7, the structure of an individual data segment 86 having the identifier “NM1” is Illustrated. FIG. 8 illustrates a loop 87 for processing the data segment 86 of FIG. 7. Individual data segments 86 like NM1 are used to supply different information in different data processing loops such as processing loop 87. Respective data segments, such as data segment 86, for example, contain individual data elements such as data elements 93, 94 and 95. Respective data elements correspond to data field as that term is commonly used in data processing terminology. The data element is the smallest named item within the ANSI EDI standard. A data segment corresponds to a record as used in data processing terminology. Respective data segments, such as data segment 86, for example, begin with a segment identifier, such as identifier 93, and contain related data elements.

The ANSI 837I standard specifies various loop structures that require related data segment elements to be processed in a particular sequence in order to verify the integrity of the output data produced. The data segment 86 (NM1) is used to provide information identifying an individual or organization. The data segment 86 (NM1), for example, can be used to provide information such as the submitter name, patient name and/or subscriber name. The number of data elements within each individual data segment that are valued varies depending upon which loop is processing the data segment, i.e. which individual or organization is being identified. The valued data elements are a subset of the entire set of data elements which could be present in a model data segment. The loop 87, for example, is used to process the submitter name 88. When using the submitter name loop 87, elements 89 (NM106), 90 (NM107), 91 (NM110) and 92 (NM111) would not be valued in the NM1 data segment 86.

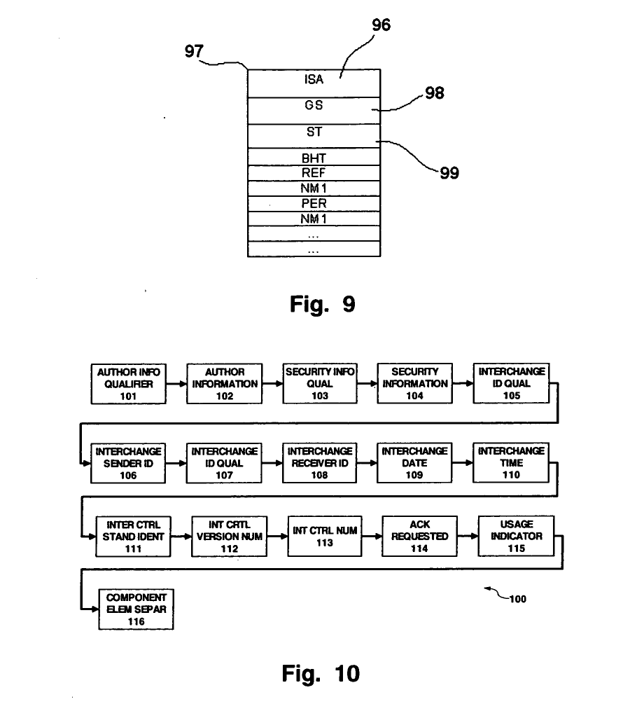

A claim in the ANSI837 data format output is constructed by the claims processor 9 by following the standards set forth in the National Electronic Data Interchange Transaction Set Implementation Guide, for example. An array of segment objects 13B is created by sequentially adding the correct data segments in the correct order. Depending upon which loop in the transaction is being executed, the correct number of data elements is filled in for each data segment constructed. FIG. 9 illustrates an example of data segments present within a typical EDI data segment array 97. The first data segment 96 has the identifier ISA. The ISA data segment 96 is the interchange control header and is used to start and identify an interchange of zero or more functional groups and interchange related control segments. Within each segment object such as segments 96, 98 and 99, for example, data elements are either valued or null, as described above.

FIG. 10 illustrates the data elements for the ISA data segment 96 (FIG. 9) as processed by loop 100. In the ISA data segment, the data elements illustrated are fixed in length, are required and no nulls are permitted. One skilled in the art understands that other data segments may include data elements of variable length, optional data elements and/or data elements which may be represented by null data. In FIG. 10, the data element 101 is an author information qualifier and contains “00”; the data element 102 contains author information; the data element 103 is a security information qualifier and contains “00”; the data element 104 contains security information; the data element 105 is a first interchange identification qualifier and contains “30”; the data element 106 contains the identification of the interchange sender which may be a taxpayer identification number or any other such identifier (e.g. 111111240795508); the data element 107 is a second interchange identification qualifier and contains “ZZ”; the data element 108 contains the identification of the interchange receiver; the data element 109 contains the interchange date; the data element 110 contains the interchange time; the data element 111 is an interchange control standard identifier and contains “U”; the data element 112 contains the interchange control version number, e.g. 00401; the data element 113 contains an interchange control number, e.g. 123456789; the data element 114 contains data indicating when an acknowledgement is requested, e.g. 0—no, 1—yes; data element 115 is a usage indicator and contains “P”; and the data element 116 is a component element separator and contains“:”.

When generating an EDI claim, as claim data elements 3 (FIG. 1) are processed the national rule base 16 (FIG. 2), the first set of rules executed by the national level rule set 33 creates an array of data segments 13B, such as the array 97 illustrated in FIG. 9, specified according to the 837 standard as set forth in the National Electronic Data Interchange Transaction Set Implementation Guide. The successive payer specific level rule sets, contained within the payer specific rule base 18, include individual rules which may be executed to modify this array of data segments 13B, either by inserting or deleting data segments, or by modifying individual data elements within a specific segment. The net result of the execution of the rule sets within system 1 is the creation of a payer specific 837 compliant electronic transaction in the form of an ordered array of segment objects 13B. The correct delimiters are inserted between data elements and data segments by claims processor 9.

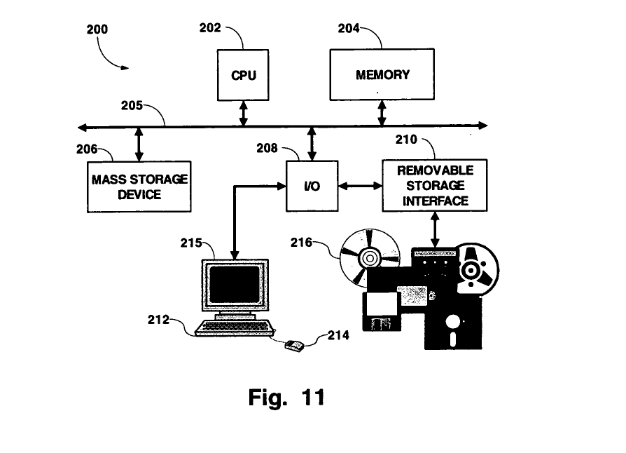

FIG. 11 is a block diagram of a processing system 200 on which the claim processing system according to the present invention may be implemented. The processing system 200 includes a central processing unit (CPU) 202, a memory 204, a mass storage device 206, and an input/output interface 208 coupled together by a computer bus 205. The input/output (I/O) interface 208 is coupled to a user interface consisting of a monitor 215, a keyboard 212 and a pointing device, which in the illustrated embodiment is a mouse 214. The I/O interface 208 is also coupled to a removable storage interface 210 capable of retrieving data from or storing data on one or more tangible electronic data storage media 216. The tangible electronic data storage media 216 may include magnetic devices such as reel-to-reel computer tape, cassette tapes, and magnetic disk media such as floppy disks and so forth. The tangible electronic data storage media 216 may also include optical devices, such as digital video disk (DVD) or compact disk (CD) and so forth. One skilled in the art understands that any such electronic data storage media 216 may be used, such as portable storage devices including semiconductor memory integrated circuits. The I/O interface 208 may also be coupled to other peripheral devices (not shown) such as printers or communications devices for communicating with remote systems, local area networks (LANs) or wide area networks (WANs) such as the internet.

In operation, the CPU 202 operates as a processor which executes the machine readable instructions forming an executable application and/or executable procedures. Those machine readable instructions are stored in the memory 204, which may consist of read-only memory (ROM) and/or read/write memory (RAM). The CPU 202 retrieves the machine readable instructions from the memory 204 and executes them to perform the operations of the information acquisition system, as described above.

In the illustrated embodiment, the I/O processor 208 includes a display processor which, in response to commands from the CPU 202, generates signals representing display images for a user, and supplies those image representative signals to the monitor 215 which displays the images. The I/O processor 208 also receives user commands and data from the keyboard 212 and/or mouse 214 and provides that information to the CPU 202. The CPU 202 responds to the received user 2 commands and data to control the operation of the information acquisition system as described above.

Data may be retrieved from and stored in the mass storage device 206. For example, the mass storage device 206 may provide storage for the rules repository 5 (FIG. 1). The mass storage device 206 may also store data representing the machine readable instructions forming the executable application and/or executable procedures. The CPU 202 may retrieve the executable application and/or executable procedures from the mass storage device 206 and store them in the memory 204. The CPU 202 may retrieve the machine readable instructions from the memory 204 and execute the executable application and/or executable procedures to perform the information acquisition activities described above.

Data may also be retrieved from and stored in the tangible electronic data storage media 216 via the removable storage interface 210. Any data may be stored in and/or retrieved from the tangible electronic data storage media. More specifically, in the illustrated embodiment, the machine readable instructions in the executable application and/or executable procedures forming the information acquisition system may be stored in a tangible electronic data storage medium. The CPU 202 may condition the I/O processor 208 to retrieve the executable application and/or executable procedures from the appropriate electronic data storage medium via the removable storage interface 210, and to store the executable application and/or executable procedures in the mass storage device 206 and/or the memory 204. The CPU 202 may execute the executable application and/or executable procedures in the memory 204 to perform the information acquisition activities described above.

A system as described above is a Business Rules Engine (BRE) system that structures technical and business information to support the computerized development and continuous maintenance of claims for multiple payers for use by providers, especially those that use the Application Service Provider (ASP) technology. An ASP is a provider of a service, such as a claim data verification and claim generation service, which maintains a central facility for performing the service and interacts with customers via the internet to receive input data and provide resulting data. Such a service permits the central facility to maintain current and accurate processing. The present system reduces redundant development by sharing development and use of common components across multiple payer requirements while permitting customers to modify those components at their own sites.

In summary, a claims creation system constructed according to the principles of the present invention minimizes the number of rules needed to format a claim, isolates rules into different rule bases in order to simplify maintenance and support, and enables payer and customer specific rules to override the generic national rules in order to produce payer and customer specific claims. In a preferred embodiment the BRE system uses the Blaze Advisor™ computer program, for example, to write, test, and deploy rules enabling claim generation. The Blaze Advisor computer program is a product of Fair, Isaac & Company, 200 Smith Ranch Road, San Rafael, Calif. 94903-5551. The present BRE system employs an architectural structure, using the Blaze Advisor program, for example, to develop claims efficiently.

The present invention improves the process of maintaining and supporting claim processing rules, and concurrently provides customized support of payer and customer rules as those rules are defined in payer companion guides and provider/payer contracts for specific types of claims. The present system is structured to allow for the creation and execution of appropriate rules based on the claim data and the type of claim. The system advantageously organizes rules into rule bases or other structures for both maintainability and the independent deployment of rules. By organizing the rules into national, payer, and customer specific databases, rule maintenance, testing, and deployment is concurrently supported across a large and geographically dispersed customer base.

The present system can be applied to both electronic and paper claims, including specialty claims such as organ transplant claims. The system executes the minimum set of rules to produce a specific claim and can account for nuances of payer specific claims. The system allows the rules to be supported and maintained by the customer, and allows updated rules to be deployed in a manner affecting only those customers that execute the changed rules. The system uses hierarchical levels of rules run in order of priority, in combination with particular output structures for both paper and electronic claims.

The system categorizes rules into different hierarchical levels which improve data processing efficiency by causing global rules that apply to many situations or payers to be retrieved only once. Exceptional or unusual rules that apply only to specific payers or unique situations are isolated at a lower level and executed after global rules. The exceptional rules override specific output fields. Hierarchical rule levels simplify the support and maintenance of rules. Rules that apply to a group of payers reside at a higher, relatively more universal level and thus execute sooner than rules that apply to more specific situations. The successive ranking of rules quickly identifies those rules required to formulate a specific claim. Isolation of dedicated rules at a customer level allows for customer maintenance of their own claim rules. The rules associated with multiple diverse customers are maintained and deployed without interaction between customers. The hierarchal, isolated rule level structure ensures that the deployment of payer specific rule sets will not affect a customer whose transactions involve an unrelated payer.

The present system supports different types of claims, including both electronic and paper claims, for various individual payers and customers. The output structure for both paper and electronic claims produced as a result of examination by and conformance to the rules employs object oriented programming, allowing rules to be simple and organized while permitting flexibility in creating payer specific output. Output objects are passed downstream so as to permit other functions to render the claim. Rules within rule sets are organized by output form position or transaction position. Payer specific rules can alter the claim data output by adding, changing, or deleting elements and objects.

The system architecture advantageously enables production of different types of payer specific claims in an efficient, logical, and maintainable manner. The system may be used to define specifications for healthcare claims. The system reduces requirements management by streamlining the claims creation process. The present system allows users to better manage their claims transactions whenever the format of a claim changes by reducing the time and cost associated with processing claim data for use with differing formats.

Although the present invention has been described in some detail, even with respect to the healthcare field there are numerous variations and modifications that will become apparent to those skilled in this field once this disclosure is fully appreciated.

What is claimed is:

1. A system for processing claim data related to provision of healthcare to a patient, comprising:
an interface processor for receiving claim data comprising data related to a claim for provision of healthcare to a particular patient and including a claim type identifier;
at least one repository including:
predetermined claim generation rules for use in generating a claim for submission to a payer institution, said claim generation rules being hierarchically organized to enable more frequently applied rules to be identified and applied first, and
information associating particular rules to be applied with a particular claim type; and
a claim processor, for generating a claim of a particular type for submission to a particular payer institution by applying claim generation rules derived from said at least one repository in a predetermined priority in response to said received claim type identifier.

2. A system according to claim 1, wherein said predetermined claim generation rules are hierarchically organized into categories comprising (a) rules determining claim validity and (b) national rules.

3. A system according to claim 2, wherein said predetermined claim generation rules further include a category comprising claim data translation rules.

4. A system according to claim 2, wherein said predetermined claim generation rules are hierarchically organized into additional categories comprising at least two of: (a) payer specific rules, (b) state rules, and (c) healthcare provider institution specific rules and said rules of claim 2 are subject to be overridden by said rule of said additional categories.

5. A system according to claim 4, wherein said payer specific rules comprise payer encounter or service related rules and said healthcare provider institution specific rules comprise healthcare provider service or procedure specific rules.

6. A system according to claim 4, wherein said healthcare provider institution specific rules are separately accessible and updateable by a user independently of other rules.

7. A system according to claim 1, wherein said hierarchically organized claim generation rules include a first rule and a second rule and said second rule is applied subsequent to said first rule and overrides a function performed by said first rule.

8. A system according to claim 1, wherein said predetermined claim generation rules include sets of rules and rules for processing particular claim data elements are hierarchically organized within a rule set by at least one of: (a) data element position within a claim form, and (b) data element position within an electronic transaction message.

9. A system according to claim 1, wherein:
said claim processor generates data representing said claim of said particular type as a plurality of data objects; and
said data objects are collated and processed to produce a claim of a particular type in response to said claim type identifier.

10. A system according to claim 9, wherein said data objects are collated and processed to produce at least one of: (a) an electronic claim, and (b) a paper claim.

11. A system according to claim 1, wherein said claim type identifier identifies a claim types as at least one of: (a) an ANSI 837 compatible electronic claim, (b) a UB92 claim, (c) an American Dental Association (ADA) standard compatible claim, (d) a Health Care Financing Administration (HCFA) standard compatible claim, and (e) a specialty claim.

12. A system according to claim 1, wherein a rule comprises a procedure for ensuring generated claim elements comply with predetermined requirements including at least one of: (a) health plan reimbursement conditions, (b) health plan format requirements, (c) a reimbursement formula, (d) reimbursement constraints, and (e) reimbursement computation procedure.

13. A system according to claim 12, wherein said claim elements comprise at least one of: (i) a portion of a claim, (ii) a complete claim, (iii) individual records of a claim, and (iv) record data associated with an individual patient encounter with a healthcare service provider.

14. A system according to claim 1, wherein:
said rules repository associates a time period of validity with an individual rule; and
said claims processor examines said rule validity period and does not apply a rule at a time and date falling outside of said rule validity period.

15. A system according to claim 1, wherein said interface processor transforms acquired rules to a syntax suitable for storage in said rules repository.

16. A system according to claim 1, wherein said more frequently applied rules are rules for producing a claim type for a group of payer institutions.

17. A system according to claim 16, wherein said more frequently applied rules further comprise rules for producing, in prioritized order, a claim type for: (i) a particular payer institution, (ii) a particular encounter type, and (iii) a particular service or procedure type.

18. A method for processing claim data related to provision of healthcare to a patient, comprising the activities of:
receiving claim data comprising data related to a claim for provision of healthcare to a particular patient and including a claim type identifier;
organizing predetermined claim generation rules to enable more frequently applied rules to be identified and applied first, said claim generation rules being for use in generating a claim for submission to a payer institution;
associating particular rules to be applied with a particular claim type; and
generating a claim of a particular type for submission to a particular payer institution by applying claim generation rules in a predetermined priority based on said hierarchical organization and in response to said received claim type identifier.

19. A tangible storage medium incorporating machine readable instructions for performing the activities of claim 18.

20. The method of claim 18, further comprising the activity of hierarchically organizing the predetermined claim generation rules into categories comprising (a) rules determining claim validity and (b) national rules.
